(19) United States
(12) Patent Application Publication
(10) Pub. No.: US 2021/0041889 A1
(43) Pub. Date: Feb. 11, 2021

(54) SEMANTIC MAP ORIENTATION DEVICE AND METHOD, AND ROBOT

(71) Applicant: PEGATRON CORPORATION, TAIPEI CITY (TW)

(72) Inventors: Yung-Ching CHEN, TAIPEI CITY (TW); Kuang-Hsun HSIEH, TAIPEI CITY (TW); Hsin-Chuan PAN, TAIPEI CITY (TW)

(21) Appl. No.: 16/930,370

(22) Filed: Jul. 16, 2020

(30) Foreign Application Priority Data
Aug. 8, 2019 (TW) 108128368

(51) Int. Cl. G05D 1/02; B25J 13/00; B25J 9/00; G10L 15/22; G06K 9/00

(52) U.S. Cl. CPC G05D 1/0274; G05D 1/0246; B25J 13/003; G10L 2015/223; G10L 15/22; G06K 9/00664; B25J 9/0003

(57) ABSTRACT

A semantic map orientation device includes an image capturing device, a memory, and a processor. The memory stores map information, where the map information defines at least one zone in a space. The processor captures a semantic attribute list, where the semantic attribute list includes a plurality of object combinations and a plurality of spatial keywords, and the spatial keywords correspond to the object combinations respectively. The processor is configured to access the map information, control the image capturing device to capture image information corresponding to one of the at least one zone, and determine whether a plurality of objects captured in the image information matches one of the object combinations in the semantic attribute list. If the objects captured in the image information match the object combination, the processor classifies the zone into the spatial keyword corresponding to the object combination to update the map information.

### CROSS-REFERENCE TO RELATED APPLICATION

This non-provisional application claims priority under 35 U.S.C. § 119(a) to Patent Application No. 108128368 filed in Taiwan, R.O.C. on Aug. 8, 2019, the entire contents of which are hereby incorporated by reference.

### BACKGROUND

### Field of Invention

The application relates to an electronic device, a control method, and a robot, and in particular, to a device, a control method, and a robot that perform orientation based on a semantic map.

### Description of Related Art

Computer vision (Computer Vision, CV) can be used for establishing a semantic map. However, a classification error of an algorithm may cause an inaccurate determining result. In the prior art, room segmentation may be determined by detecting the position of “doors”. However, in this determining manner, semantic differences of zones in a space cannot be reliably defined.

### SUMMARY

To resolve the foregoing problem, the application provides the following embodiments, so that an electronic device and a robot use a semantic map to perform a variety of applications.

An embodiment of the application relates to a semantic map orientation device. The semantic map orientation device at least includes an image capturing device, a memory, and a processor. The image capturing device and the memory are coupled to the processor. The memory stores map information, where the map information defines at least one zone in a space. The processor captures a semantic attribute list, where the semantic attribute list includes a plurality of object combinations and a plurality of spatial keywords, and the spatial keywords correspond to the object combinations respectively. The processor is configured to perform the following steps: accessing the map information; controlling the image capturing device to capture image information corresponding to one of the at least one zone; determining whether a plurality of objects captured in the image information matches one of the object combinations in the semantic attribute list; and if the objects captured in the image information match the object combination, classifying the zone into the spatial keyword corresponding to the object combination to update the map information.

Another embodiment of the application relates to a semantic map orientation method. The object detection method is performed by a processor. The semantic map orientation at least includes the following steps: accessing map information, where the map information defines at least one zone in a space; controlling an image capturing device to capture image information corresponding to the at least one zone; determining whether a plurality of objects captured in the image information matches one of a plurality of object combinations in a semantic attribute list, where the semantic attribute list includes the object combinations and a plurality of spatial keywords, and the spatial keywords correspond to the object combinations respectively; and if the objects captured in the image information match the object combination, classifying the zone into the spatial keyword corresponding to the object combination to update the map information.

Still another embodiment of the application relates to a robot, where the robot has a semantic map orientation function. The robot includes an image capturing device, a mobile device, an input device, a memory, and a processor. The processor is coupled to the image capturing device, the mobile device, the input device, and the memory. The input device is configured to receive an instruction. The processor captures a semantic attribute list, where the semantic attribute list includes a plurality of object combinations and a plurality of spatial keywords, and the spatial keywords correspond to the object combinations respectively. The processor is configured to: access the map information; control the image capturing device to capture image information corresponding to one of the at least one zone; determine whether a plurality of objects captured in the image information matches one of the object combinations in the semantic attribute list; if the objects captured in the image information match the object combination, classify the zone into the spatial keyword corresponding to the object combination to update the map information; determine whether the instruction received by the input device corresponds to one of the spatial keywords; and if the instruction corresponds to one of the spatial keywords, control the mobile device to move to the at least one zone corresponding to the spatial keyword.

Therefore, according to the foregoing embodiments of the application, at least a semantic map orientation device and method, and a robot are provided in the application. A spatial attribute that can be used for semantic identification may be attached to a conventional map, so that the electronic device and the robot perform a variety of applications by using a semantic map.

### BRIEF DESCRIPTION OF THE DRAWINGS

With reference to the embodiments in the subsequent paragraphs and the following drawings, content of the present invention may be comprehended better.

FIG. 1 is a schematic diagram of a semantic map orientation device according to some embodiments of the application;

FIG. 2 is a schematic diagram of a semantic map orientation robot according to some embodiments of the application;

FIG. 3 is a flowchart of a semantic map orientation method according to some embodiments of the application;

FIG. 4 is a schematic diagram of map information according to some embodiments of the application;

FIG. 5 is a schematic diagram of performing object detection by a semantic map orientation robot according to some embodiments of the application; and

FIG. 6 to FIG. 11 are schematic diagrams of scenarios of a semantic map orientation method according to some embodiments of the application.

### DETAILED DESCRIPTION

The following clearly describes spirit of the application with reference to the drawings and detailed description, and after understanding embodiments of the application, a person of ordinary skill in the art may make variations and modifications with reference to the technologies taught in the application without departing from the spirit and scope of the application.

“Couple” or “connect” used in this specification may mean that two or more elements or devices are in direct physical contact with each other or in indirect physical contact with each other, or may also mean that two or more elements or devices perform mutual operations or actions.

Terms used in this specification such as “comprise”, “include”, “have”, and “contain” are all open terms, which means including but not limited to.

“And/or” used in this specification means any one or all combinations of the objects.

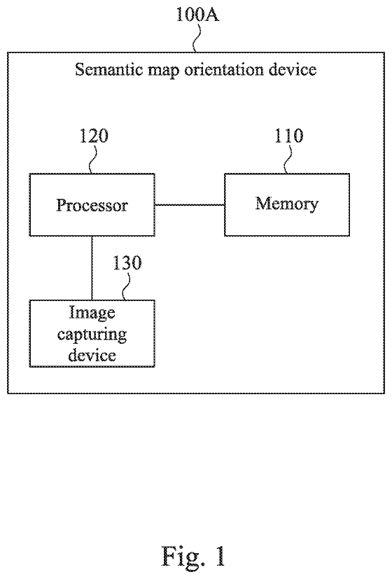

FIG. 1 is a schematic diagram of a semantic map orientation device according to some embodiments of the application. As shown in FIG. 1, in some embodiments, a semantic map orientation device 100A includes a memory 110 and a processor 120, and the memory 110 is coupled electrically/in a communications manner to the processor 120. In some other embodiments, the semantic map orientation device 100A further includes an image capturing device 130, and the image capturing device 130 is also electrically/communicatively coupled to the processor 120. However, the hardware architecture of the semantic map orientation device 100A is not limited thereto.

In some embodiments, the memory 110, the processor 120, and the image capturing device 130 of the semantic map orientation device 100A may constitute an arithmetic device that operates independently. In some embodiments, the image capturing device 130 is mainly configured to capture image (or continuous image streaming) information in a specific space, so that the processor 120 can process, according to a computer-readable instruction stored in the memory, the image information captured by the image capturing device 130, thereby implementing a function of the semantic map orientation device 100A.

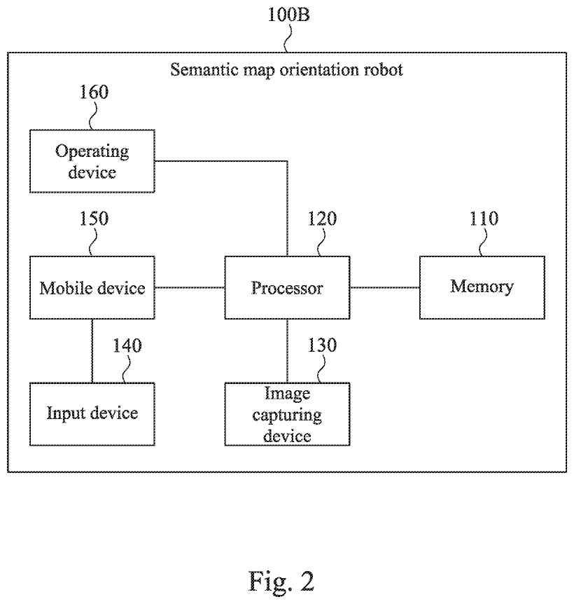

FIG. 2 is a schematic diagram of a semantic map orientation robot according to some embodiments of the application. As shown in FIG. 2, in some embodiments, a semantic map orientation robot 100B includes elements of the semantic map orientation device 100A shown in FIG. 1. Specifically, the semantic map orientation robot 100B includes the memory 110, the processor 120, the image capturing device 130, an input device 140, a mobile device 150, and an operating device 160. As shown in FIG. 2, the devices are all electrically/communicatively coupled to the processor 120. However, the hardware architecture of the semantic map orientation robot 100B is not limited thereto.

In some embodiments, the memory 110, the processor 120, the image capturing device 130, and the input device 140 may constitute an arithmetic unit of the semantic map orientation robot 1006, while the mobile device 150 and the operating device 160 may constitute an operating unit of the semantic map orientation robot 100B. The arithmetic unit and the operating unit may operate collaboratively, thereby implementing a function of the semantic map orientation robot 100B (for example, controlling the mobile device 150 and the operating device 160 to complete a specific action corresponding to an external instruction).

It should be understood that “electrical coupling” or “communicative coupling” referred to in the application may be physical or unphysical coupling. For example, in some embodiments, the processor 120 may be coupled to the memory 110 by using a wireless communications technology, so that both sides can perform bidirectional information exchange. In some embodiments, the memory 110 and the processor 120 may be coupled by using a physical wire, so that both sides can also perform bidirectional information exchange. The foregoing embodiments can all be referred to as “electrical coupling” or “communicative coupling”.

In some embodiments, the memory 110 may include but is not limited to one of a flash memory, a hard disk drive (HDD), a solid state drive (SSD), a dynamic random access memory (DRAM) or a static random access memory (SRAM), or a combination thereof. In some embodiments, as a non-transient computer-readable medium, the memory 110 can store at least one computer-readable instruction, and the computer-readable instruction can be accessed by the processor 120. The processor 120 can execute the computer-readable instruction to run an application program, thereby implementing the function of the semantic map orientation device 100A. It should be understood that the application program is mainly an application program that connects map information with specific semantic keywords.

In some embodiments, the processor 120 may include but is not limited to a single processor or an integration of a plurality of microprocessors, for example, a central processing unit (CPU), a graphics processing unit (GPU), or an application specific integrated circuit (ASIC). With reference to the foregoing descriptions, in some embodiments, the processor 120 may be configured to access the computer-readable instruction from the memory 110 and execute the computer-readable instruction to run the application program, thereby implementing the function of the semantic map orientation device 100A.

In some embodiments, the image capturing device 130 may include but is not limited to a general purpose optical camera, an infrared camera, a depth camera or a rostrum camera. In some embodiments, the image capturing device 130 is a device that can independently operate, which can independently capture and store image streaming. In some embodiments, the image capturing device 130 may capture image streaming and store the image streaming into the memory 110. In some embodiments, the image capturing device 130 may capture image streaming, and the image streaming is stored into the memory 110 after being processed by the processor 120.

In some embodiments, the input device 140 may include various receivers configured to receive information from the outside. For example, audio information from the outside is received by using a microphone, a temperature outside is detected by using a thermometer, a brainwave of a user is received by using a brainwave detector, an operation input of a user is received by using a keyboard or a touch display, and the like. In some embodiments, the input device 140 may perform functions such as basic signal pre-processing, signal conversion, signal filtering, and signal amplification, but the application is not limited thereto.

In some embodiments, the mobile device 150 may include a combination of various mechanical devices and driving devices, for example, a combination of a motor, a track, a wheel, a mechanical limb, a joint mechanism, a steering machine, a shock absorber, and the like. In some embodiments, the mobile device 150 may be configured to move the semantic map orientation robot 100B in a specific space.

In some embodiments, the operating device 160 may include a combination of various mechanical devices and driving devices, for example, a combination of a motor, a mechanical limb, a joint mechanism, a steering machine, a shock absorber, and the like. In some embodiments, the operating device 160 enables the semantic map orientation robot 100B to perform a specific interactive operation with an object, for example, grabbing an object, moving an object, putting down an object, assembling an object, destroying an object, and the like.

To better understand the application, detailed content of the application program run by the processor 120 of the semantic map orientation device 100A and the semantic map orientation robot 100B is explained in the following paragraphs.

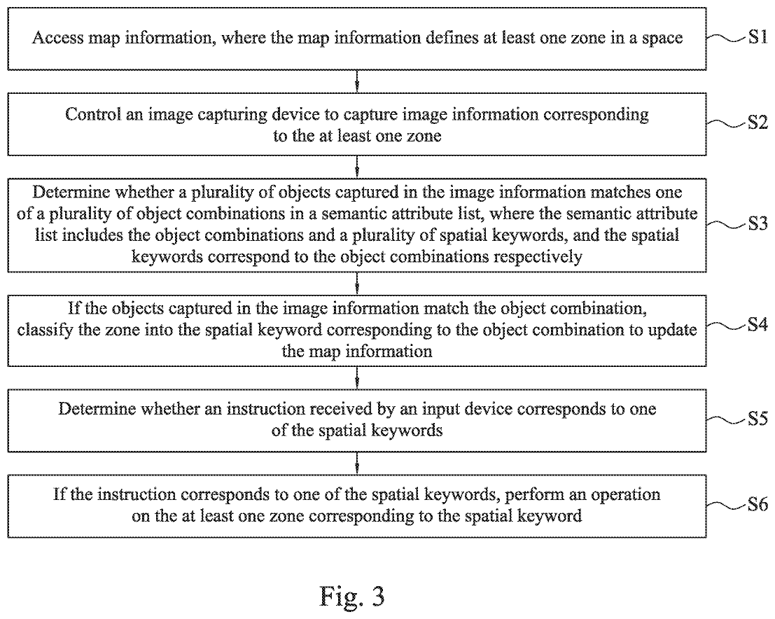

FIG. 3 is a flowchart of a semantic map orientation method according to some embodiments of the application. In some embodiments, the semantic map orientation method may be implemented by the semantic map orientation device 100A in FIG. 1 or the semantic map orientation robot 1008 in FIG. 2. To better understand the following embodiments, refer to the embodiments of FIG. 1 and FIG. 2, and operation of units in the semantic map orientation device 100A or the semantic map orientation robot 1008 together.

Specifically, the semantic map orientation method shown in FIG. 3 is the application program described in the embodiments of FIG. 1 and FIG. 2, which is run by the processor 120 reading a computer-readable instruction from the memory 110 and executing the computer-readable instruction. In some embodiments, detailed steps of the semantic map orientation method are shown as follows.

S1: Access map information, where the map information defines at least one zone in a space.

In some embodiments, the processor 120 may access, from a storage device (for example, the memory 110 or a cloud server), specific map information, and in particular, map information of a space in which the semantic map orientation device 100A and/or the semantic map orientation robot 1008 is located. For example, if the semantic map orientation device 100A and/or the semantic map orientation robot 100B is disposed in a house, the map information may be floor plan information of the house. The map information may record position information of a plurality of dividers (for example, walls and in-built furniture) in the house, and the dividers define a plurality of zones in the house. However, the map information in the application is not limited thereto.

In some embodiments, the map information may be generated by the processor 120. For example, the semantic map orientation robot 100B may move in a space by using the mobile device 150. In a moving process of the semantic map orientation robot 100B, the semantic map orientation robot 100B may capture, by using a specific optical device (for example, an optical radar device or the image capturing device 130), various information of the semantic map orientation robot 100B relative to the space where it is located (for example, a distance between the optical radar device and an obstacle in the space). The processor 120 may adopt a specific simultaneous localization and mapping (SLAM) algorithm (for example, the Google Cartographer algorithm) to generate a floor plan of the space, and then process the image information by using a specific room segmentation algorithm (for example, the Voronoi Diagram segmentation algorithm), to segment a plurality of zones in the space (for example, a position of a door is used as a divider of zones). In this way, the processor 120 may generate the map information and confirm a plurality of zones in the space.

In some embodiments, the room segmentation algorithm may include the following steps: (A). generating a generalized Voronoi Diagram according to a sampling result obtained by the image capturing device in the space; (B). determining whether to reduce a quantity of critical points according to a distance between the critical points in the Voronoi Diagram, thereby reducing the amount of system computation; (C). planning critical lines according to the critical points to segment a plurality of spaces in the Voronoi Diagram, and determine whether to reduce a quantity of the critical lines according to an angle between the critical lines; and (D). determining whether to combine adjacent spaces to be a single space according to a ratio of partition walls.

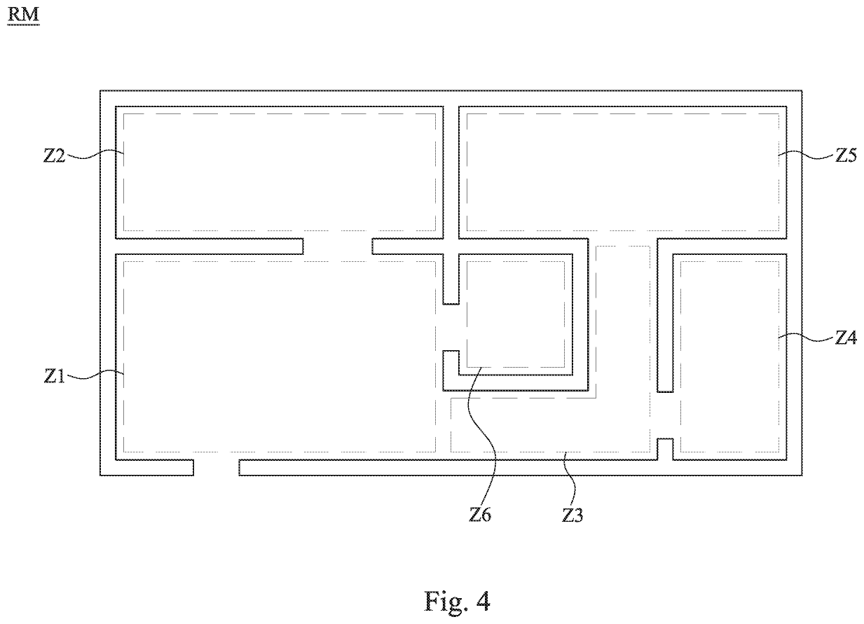

To better understand the map information, refer to FIG. 4, which is a schematic diagram of map information according to some embodiments of the application. As shown in FIG. 4, a floor plan RM shows a plurality of zones Z1 to Z6 in a house, and each zone corresponds to a physical room or a corridor in the house respectively. As shown in FIG. 4, the zone Z1 is connected to the zone Z2, the zone Z3, and the zone Z6. The zone Z3 is connected to the zone Z1, the zone Z4, and the zone Z5.

S2: Control an image capturing device to capture image information corresponding to the at least one zone.

In some embodiments, the processor 120 may control the image capturing device 130 to capture an image in each zone defined by the map information, thereby generating a plurality of image information. For example, the processor 120 of the semantic map orientation robot 100B may control, according to specific logic (for example, traversal search), the mobile device 150 to move, so that the semantic map orientation robot 100B moves in the house corresponding to the floor plan RM. In a moving process, the processor 120 may control the image capturing device 130 to capture an image in rooms or corridors corresponding to the zones Z1 to Z6 respectively.

In some embodiments, the processor 120 may control the image capturing device 130 to perform horizontal or vertical rotation, to comprehensively obtain images of each room or corridor. In this way, the processor 120 may obtain image information corresponding to the zones Z1 to Z6. In some embodiments, the processor 120 may store the image information in a specific storage device (for example, the memory 110).

S3: Determine whether a plurality of objects captured in the image information matches one of a plurality of object combinations in a semantic attribute list, where the semantic attribute list includes the object combinations and a plurality of spatial keywords, and the spatial keywords correspond to the object combinations respectively.

In some embodiments, the processor 120 may analyze, according to a specific object detection algorithm in a computer vision (CV) technology, image information captured by the image capturing device 130, to identify whether the image includes corresponding specific objects (for example, a window, a door, furniture, a commodity, and the like) and to obtain coordinate information of the objects in the space.

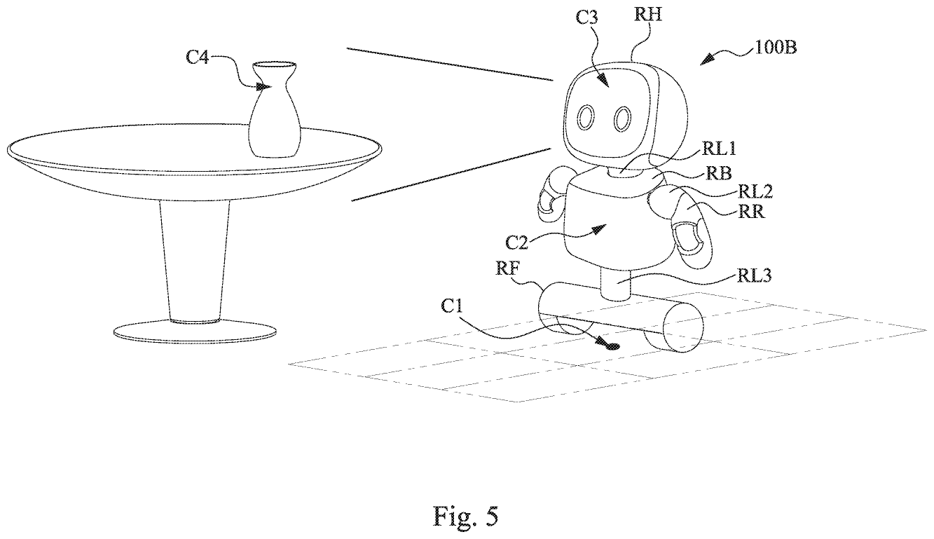

To better understand the object detection algorithm executed by the processor 120, refer to FIG. 5, which is a schematic diagram of performing object detection by a semantic map orientation robot according to some embodiments of the application. In some embodiments, an appearance of the semantic map orientation robot 100B is shown in FIG. 5. The semantic map orientation robot 100B may include a plurality of components, which may be roughly distinguished according to appearance as a head RH, joints RL1 to RL3, a body RB, an arm RR, and a foundation RF. The head RH is coupled to the body RB in a multi-directionally rotatable manner by using the joint RL1, the arm RR is coupled to the body RB in a multi-directionally rotatable manner by using the joint RL2, and the foundation RF is coupled to the body RB in a multi-directionally rotatable manner by using the joint RL3. In some embodiments, the image capturing device 130 is disposed at the head RH, the mobile device 150 is disposed at the foundation RF, and the operating device 160 is disposed at the arm RR.

In some embodiments, the semantic map orientation robot 100B performs various predetermined operations by using a robot operating system (ROS). Generally, connection relationships or rotation angles of the head RH, the joints RL1 to RL3, the body RB, the arm RR, and the foundation RF of the semantic map orientation robot 100B may be stored as specific tree structure data in the robot operating system. When the image capturing device 130 continuously captures image information in the environment and detects objects, the processor 120 may execute a coordinate conversion program according to the components in the tree structure data as reference points, to convert locations of the detected objects in a camera color optical frame into a world map, and store world map coordinates of the detected objects into a semantic map database in a specific storage device (for example, the memory 110 or another memory). For example, when the foundation RF of the semantic map orientation robot 100B is located at coordinates Cl in the world map, according to a distance and a rotation angle between the foundation RF and the body RB defined in the tree structure data, the processor 120 may obtain corresponding coordinates C2 of the body RB in the world map. Similarly, according to a distance and a rotation angle between the body RB and the head RH defined in the tree structure data, the processor 120 may obtain coordinates C3 corresponding to the head RH. When the image capturing device 130 located at the head detects a specific object in an environment, the processor 120 may obtain and store coordinates C4 corresponding to the object by using the world map coordinate conversion program (that is, the coordinates C1 to C3 as used reference points) for mutual reference.

However, it should be understood that the foregoing object detection algorithm is merely used as an example but is not intended to limit the application, and other feasible object detection algorithms are also included in the protection scope of the application. Similarly, the appearance and structure of the semantic map orientation robot 100B are also merely used as an example but is not intended to limit the application, and the protection scope of the application also includes other feasible robot designs.

In some embodiments, the processor 120 may access a semantic attribute list from a specific storage device (for example, the memory 110), or the processor may have another memory (for example, a memory configured to implement the foregoing semantic map database) configured to store the semantic attribute list. The semantic attribute list includes information about a plurality of specific object combinations (for example, a combination of a window, a door, furniture, a commodity, and the like), and each object combination may correspond to a specific keyword. In some embodiments, meanings of the keywords are generally used to define uses or properties of spaces, for example, living room, kitchen, bedroom, bathroom, balcony, stairs, and the like. That is, the keywords stored in the semantic attribute list may be understood as spatial keywords.

In some embodiments, the processor 120 may determine, according to the semantic attribute list, whether image information captured by the image capturing device 130 includes a specific object combination. For example, the processor 120 may determine, according to an image corresponding to the zone Z1, whether the zone Z1 includes a combination of furniture such as a sofa and a television. For another example, the processor 120 may determine, according to an image corresponding to the zone Z2, whether the zone Z2 includes a combination of furniture such as a gas stove and a refrigerator.

S4: If the objects captured in the image information match the object combination, classify the zone into the spatial keyword corresponding to the object combination to update the map information.

With reference to the foregoing descriptions, the meanings of the keywords are generally used to define uses or properties of spaces. In some embodiments, a correspondence between each object combination and the spatial keyword in the semantic attribute list may be predefined by a system engineer or a user. In some embodiments, the correspondence may be generated by the processor 120 by using a specific machine learning algorithm. For example, the processor 120 may obtain images about the spatial keywords (for example, living room, kitchen, bedroom, and the like) from the Internet, and repeatedly train a specific model by using a neural network algorithm, to infer whether the spatial keywords are associated with specific object combinations (for example, a gas stove and a refrigerator are disposed in a kitchen, a bed and a closet are disposed in a bedroom, and the like).

In some embodiments, the processor 120 may determine, according to a specific inference engine, whether image information includes a specific object combination. In some embodiments, the inference engine is a Naive Bayes classifier. The Naive Bayes classifier may be understood as a probability classifier, which assumes that presence of an eigenvalue (that is, a specific object) is an independent event, and specifies a specific random variable for a probability of the eigenvalue; further, inference of classification is carried out by using Bayes' Theorem. The Naive Bayes classifier may be trained by using a relatively small quantity of training samples combined with a rule of thumb. A training time for the Naive Bayes classifier is relatively less than that of deep learning, which facilitates embodiment on a hardware platform with limited resources.

In some embodiments, when the processor 120 identifies a specific object combination in image information corresponding to a zone, the processor 120 may add, to the zone, a spatial keyword corresponding to the object combination, and update/replace original map information with the map information added with the spatial keyword. In other words, such update may be understood as semantic classification performed by the processor 120 on the zone in the map information, and the semantic classification corresponds to the spatial keyword corresponding to the object combination detected in the zone. By repeatedly performing the step in each space, the processor 120 may respectively add a semantic attribute corresponding to a spatial keyword to each space, so that the original map information becomes map information having semantic attributes.

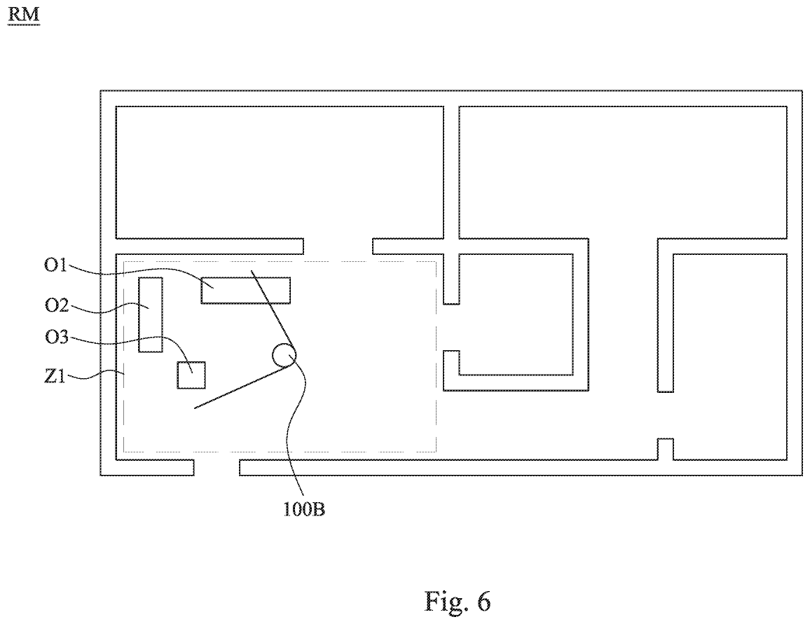

To better understand steps S220 to S240, refer to FIG. 6 to FIG. 11, which are schematic diagrams of scenarios of a semantic map orientation method according to some embodiments of the application.

In some embodiments, a semantic attribute list accessed by the processor 120 at least includes the following correspondences between “spatial keywords” and “objects”: (A) “living room” corresponds to “television”, “sofa”, and “closet”; (B) “kitchen” corresponds to “gas stove”, “refrigerator”, and “dish dryer”; (C) “bathroom” corresponds to “mirror”, “bathtub”, and “toilet”; (D) “bedroom” corresponds to “bed”, “closet”, and “mirror”, (E) “corridor” corresponds to “painting”, “handrail”, and “wallpaper”; (F) “storeroom” corresponds to “paper box”, “bicycle”, and “shelf”; and (G) “balcony” corresponds to “washer”, “hanger”, and “washbasin”. It should be understood that, in this embodiment, the object combinations corresponding to the spatial keywords overlap mutually, but the semantic attribute list is merely used for description but not for limiting the application. In some other embodiments, the semantic attribute list may include correspondences between more keywords and more object combinations.

As shown in FIG. 6, the semantic map orientation robot 100B is located in a room corresponding to the zone Z1. The processor 120 may control the image capturing device 130 to capture image information in the room corresponding to the zone Z1 and analyze whether the image information includes a specific object combination. As shown in FIG. 6, the processor 120 may identify objects O1 to O3 in the image information, where the object O1 is a sofa, the object O2 is a closet, and the object O3 is a television. The processor 120 may execute the Bayes classifier according to the foregoing semantic attribute list, and a determining result thereof is that the objects O1 to O3 match all of the object combination defined by “living room”. Therefore, there is a high probability that the room corresponding to the zone Z1 is a “living room”, and the processor 120 may add a semantic attribute of the spatial keyword “living room” to the zone Z1 in the map information.

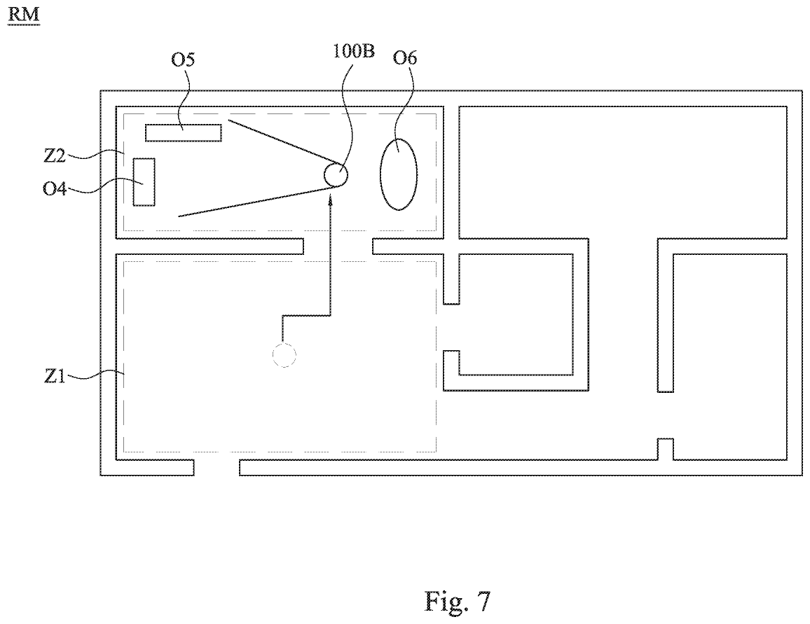

As shown in FIG. 7, the semantic map orientation robot 100B may move to a room corresponding to the zone Z2 by using the mobile device 150 and capture image information by using the image capturing device 130. As shown in FIG. 7 the processor 120 may identify objects O4 to O6 in the image information, where the object O4 is a refrigerator, the object O5 is a gas stove, and the object O6 is a dining table. The processor 120 may determine, according to the Bayes classifier, that the objects O4 to O6 match a part of the object combination defined by “kitchen” (including “gas stove” and “refrigerator”). Therefore, there is a relatively high probability that the room corresponding to the zone Z2 is a “kitchen”, and the processor 120 may add a semantic attribute of the spatial keyword “kitchen” to the zone Z2 in the map information.

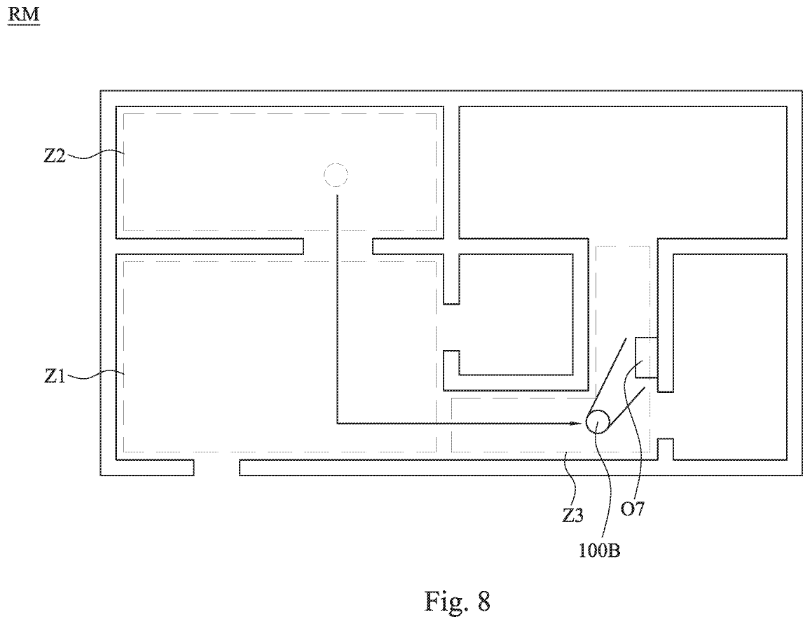

As shown in FIG. 8, the semantic map orientation robot 100B may move to a room corresponding to the zone Z3 and capture image information by using the image capturing device 130. The processor 120 may identify an object O7, which is a painting, in the image information. The processor 120 may determine, according to the Bayes classifier, that the object O7 matches a part of the object combination defined by “corridor” (only including “painting”). Therefore, there is a probability that the room corresponding to the zone Z3 is a “corridor”, and the processor 120 may add a semantic attribute of the spatial keyword “corridor” to the zone Z3 in the map information.

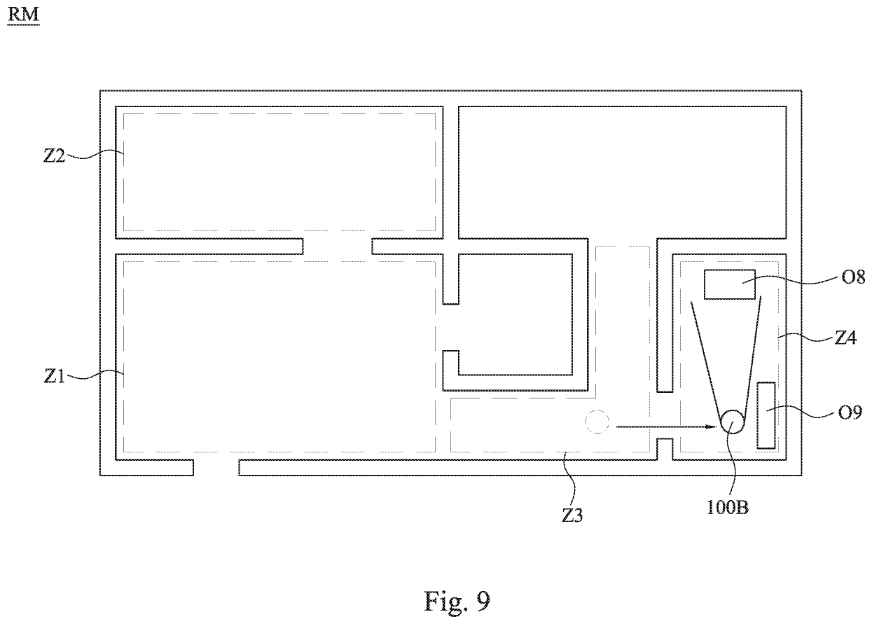

As shown in FIG. 9, the semantic map orientation robot 100B may move to a room corresponding to the zone Z4 and capture image information by using the image capturing device 130. As shown in FIG. 9, the processor 120 may identify objects O8 and O9 in the image information, where the object 08 is a bed, and the object O9 is a closet. The processor 120 may determine, according to the Bayes classifier, that the objects O8 and O9 match a part of the object combination defined by “bedroom” (including “bed” and “closet”). Therefore, there is a relatively high probability that the room corresponding to the zone Z4 is a “bedroom”, and the processor 120 may add a semantic attribute of the spatial keyword “bedroom” to the zone Z4 in the map information.

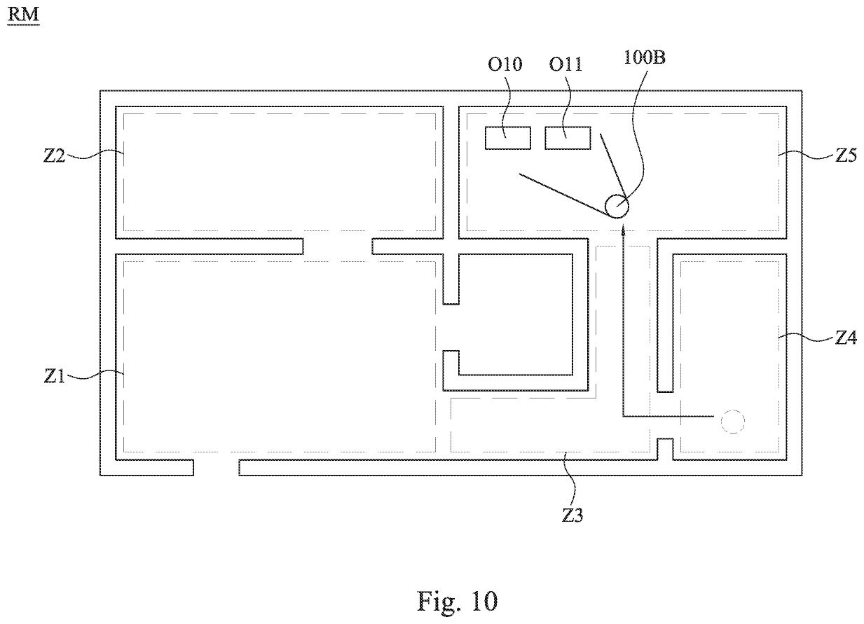

As shown in FIG. 10, the semantic map orientation robot 100B may move to a room corresponding to the zone Z5 and capture image information by using the image capturing device 130. The processor 120 may identify objects O10 and O11 in the image information, where the object O10 is a bed, and the object O11 is a desk. The processor 120 may determine, according to the Bayes classifier, that the objects O10 and O11 match a part of the object combination defined by “bedroom” (only including “bed”). Therefore, there is a probability that the room corresponding to the zone Z5 is a “bedroom”, and the processor 120 may add a semantic attribute of the spatial keyword “bedroom” to the zone Z5 in the map information.

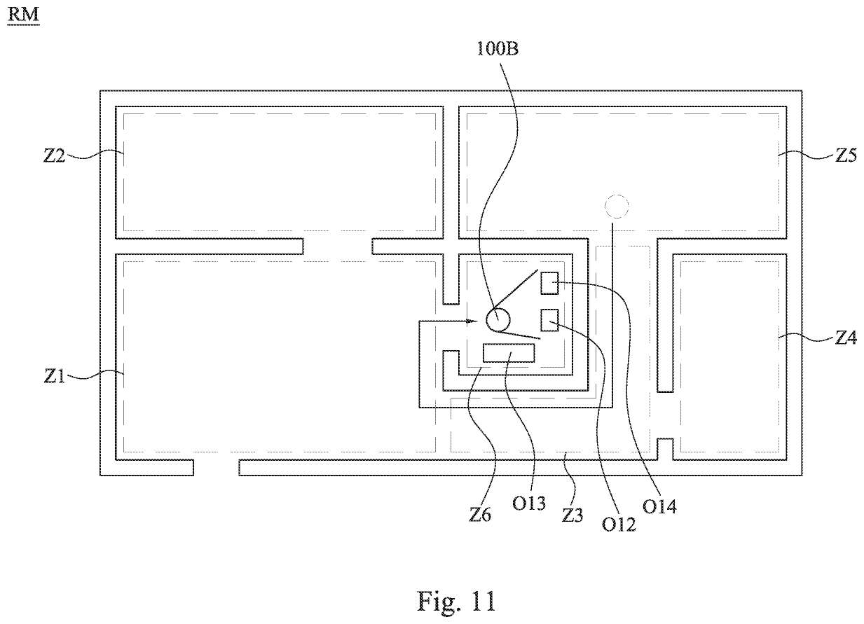

As shown in FIG. 11, the semantic map orientation robot 100B may move to a room corresponding to the zone Z6 and capture image information by using the image capturing device 130. The processor 120 may identify objects O12 to O14 in the image information, where the object O12 is a toilet, the object O13 is a bathtub, and the object O14 is a washer. The processor 120 may determine, according to the Bayes classifier, that the objects 012 to 014 match a part of the object combination defined by “bathroom” and a part of the object combination defined by “balcony” at the same time; however, a degree of matching with the object combination corresponding to the “bathroom” is higher. Therefore, there is a relatively high probability that the room corresponding to the zone Z6 is a “bathroom” instead of a “balcony”, and the processor 120 may add a semantic attribute of the spatial keyword “bathroom” to the zone Z6 in the map information.

With reference to the foregoing descriptions, the Bayes classifier executed by the processor 120 may be understood as a probability classifier, which may determine, according to a degree of matching between an object identified in image information and a definition of a spatial keyword, whether to add a semantic attribute to a specific zone. Therefore, increasing keyword classes in the semantic attribute list or increasing a complexity degree of object combinations corresponding to the spatial keywords may increase a probability of correct classification by the Bayes classifier. For example, “bedroom” may be subdivided into spatial keywords such as “master bedroom” and “child bedroom” in the semantic attribute list, or more objects may be added to the object combination defined by “bedroom”.

S5: Determine whether an instruction received by an input device corresponds to one of the spatial keywords.

In some embodiments, a user of the semantic map orientation robot 100B may input an instruction by using the input device 140 (for example, a microphone), and the processor 120 may analyze the instruction according to a specific semantic analysis algorithm, to determine whether the instruction is related to the foregoing spatial keywords used to define the zones in the space. For example, the user may input a voice command “go to kitchen to pour a glass of water for me” by using the input device 140. The processor 120 may determine whether the command is related to the foregoing spatial keywords, and a determining result of the processor 120 is that the command is related to the spatial keyword “kitchen”.

S6: If the instruction corresponds to one of the spatial keywords, perform an operation on the at least one zone corresponding to the spatial keyword.

In some embodiments, if the processor 120 determines that an instruction input by a user is related to the foregoing spatial keyword, the processor 120 may perform an operation on a zone corresponding to the spatial keyword. In some embodiments, the operation includes controlling the mobile device 150 to move to the zone corresponding to the spatial keyword. For example, with reference to the foregoing descriptions, if the processor 120 determines that the instruction is related to the spatial keyword “kitchen”, the processor 120 may control, according to the floor plan RM, the mobile device 150 to move to the room corresponding to the zone Z2. Further, because the instruction includes “pour a glass of water”, the processor 120 may control the operating device 160 at the arm RR to grab a glass and perform an action of fetching water. It should be understood that, by using the foregoing tree structure data in the robot operating system and the world map coordinate conversion program, the processor 120 may obtain world map coordinates of the “glass” and “water” in a semantic map training process. In this way, the processor 120 may correctly perform the action of fetching water.

It should be understood that the foregoing embodiments are merely used for explaining but not limiting the application, and the spirit thereof is to perform the semantic map orientation method by using the semantic map orientation robot 100B of the application, to enable the processor 120 to obtain map information having semantic attributes. Then, when the processor 120 identifies the semantic attributes in the instruction, the processor 120 may correctly direct to a corresponding space according to the semantic attributes, and perform an operation indicated by the instruction in the space. That is, by using the semantic map and world map coordinates of objects, the semantic map orientation robot 1008 may have an environment sensing function.

In the foregoing embodiments, the semantic map orientation robot 100B is used mainly as an example to explain the application, but the application is not limited thereto. It should be understood that, the processor 120 of the semantic map orientation device 100A trained by using the method of the application may still update the original map information to map information having semantic attributes, thereby directing the device to a specific zone to perform an operation.

It should be understood that in the foregoing embodiments, the semantic map orientation device 100A and the semantic map orientation robot 100B in the application include a plurality of function blocks or modules. A person skilled in the art should understand that in some embodiments, preferably, the function blocks or modules may be implemented by using a specific circuit (including a dedicated circuit or a general circuit that is operated under one or more processors and code instructions). Generally, the specific circuit may include a transistor or another circuit element, which is configured in the manner described in the foregoing embodiments, so that the specific circuit may operate according to the function and operation described in the application. Further, a coordination program between the function blocks or the modules in the specific circuit may be implemented by a specific compiler, for example, a register transfer language (RTL) compiler. However, the application is not limited thereto.

Although the application has been disclosed by the foregoing embodiments, they are not used to limit the application. Various variations and modifications can be made by any person skilled in the art without departing from the spirit and scope of the application. Therefore, the protection scope of the application should be subject to the scope defined by the appended claims.

What is claimed is:

1. A semantic map orientation device, comprising:
an image capturing device;
a memory, storing map information, wherein the map information defines at least one zone in a space; and
a processor, coupled to the image capturing device and the memory, wherein the processor captures a semantic attribute list, the semantic attribute list comprises a plurality of object combinations and a plurality of spatial keywords, and the spatial keywords correspond to the object combinations respectively, and the processor is configured to:
access the map information;
control the image capturing device to capture image information corresponding to one of the at least one zone;
determine whether a plurality of objects captured in the image information matches one of the object combinations in the semantic attribute list; and
if the objects captured in the image information match the object combination, classify the zone into the spatial keyword corresponding to the object combination to update the map information.

2. The semantic map orientation device according to claim 1, further comprising:
an input device, coupled to the processor, wherein the input device is configured to receive an instruction and determine whether the instruction corresponds to one of the spatial keywords, and if the instruction corresponds to one of the spatial keywords, the processor performs an operation on the at least one zone corresponding to the spatial keyword.

3. The semantic map orientation device according to claim 2, wherein the input device comprises a microphone, and the instruction is a voice command.

4. The semantic map orientation device according to claim 2, further comprising:
a mobile device, coupled to the processor,
wherein the operation performed by the processor is controlling the mobile device to move to the at least one zone in the space.

5. The semantic map orientation device according to claim 1, wherein the processor determines, according to a Bayes classifier, whether the objects captured in the image information match one of the object combinations.

6. The semantic map orientation device according to claim 1, wherein the processor is further configured to:
identify, according to a computer vision algorithm, the objects captured in the image information;
execute a coordinate transformation program according to a connection relationship or a rotation angle of the image capturing device relative to a plurality of reference points;
calculate, according to the coordinate transformation program, a coordinate of each of the objects in the at least one zone; and
determine, according to the coordinates, whether the objects captured in the image information are located in one of the at least one zone.

7. The semantic map orientation device according to claim 6, wherein the reference points are at least one component of a robot, and the robot is configured to carry the image capturing device, the memory, and the processor.

8. A semantic map orientation method, performed by a processor, wherein the semantic map orientation method comprises:
accessing map information, wherein the map information defines at least one zone in a space;
controlling an image capturing device to capture image information corresponding to one of the at least one zone;
determining whether a plurality of objects captured in the image information matches one of a plurality of object combinations in a semantic attribute list, wherein the semantic attribute list comprises the object combinations and a plurality of spatial keywords, and the spatial keywords correspond to the object combinations respectively; and
if the objects captured in the image information match the object combination, classifying the zone into the spatial keyword corresponding to the object combination to update the map information.

9. The semantic map orientation method according to claim 8, further comprising:
receiving an instruction by using an input device;
determining whether the instruction corresponds to one of the spatial keywords; and
if the instruction corresponds to one of the spatial keywords, controlling a mobile device to move to the at least one zone corresponding to the spatial keyword in the space.

10. The semantic map orientation method according to claim 8, wherein the instruction is a voice command.

11. The semantic map orientation method according to claim 8, wherein the determining whether the objects captured in the image information match one of the object combinations is performed according to a Bayes classifier.

12. The semantic map orientation method according to claim 8, further comprising:
identifying, according to a computer vision algorithm, the objects captured in the image information;
executing a coordinate transformation program according to a connection relationship or a rotation angle of the image capturing device relative to a plurality of reference points;
calculating, according to the coordinate transformation program, a coordinate of each of the objects in the at least one zone; and
determining, according to the coordinates, whether the objects captured in the image information are located in one of the at least one zone.

13. The semantic map orientation method according to claim 12, wherein the reference points are at least one component of a robot, and the robot is configured to carry the image capturing device and the processor.

14. A robot, having a semantic map orientation function, wherein the robot comprises:
an image capturing device;
a mobile device;
an input device, configured to receive an instruction;
a memory, storing map information, wherein the map information defines at least one zone in a space; and
a processor, coupled to the image capturing device, the mobile device, the input device, and the memory, wherein the processor captures a semantic attribute list, the semantic attribute list comprises a plurality of object combinations and a plurality of spatial keywords, and the spatial keywords correspond to the object combinations respectively, and the processor is configured to:
access the map information;
control the image capturing device to capture image information corresponding to one of the at least one zone;
determine whether a plurality of objects captured in the image information matches one of the object combinations in the semantic attribute list;
if the objects captured in the image information match the object combination, classify the zone into the spatial keyword corresponding to the object combination to update the map information;
determine whether the instruction received by the input device corresponds to one of the spatial keywords; and
when the instruction corresponds to one of the spatial keywords, control the mobile device to move to the at least one zone corresponding to the spatial keyword.

15. The robot according to claim 14, wherein the processor is further configured to:
identify, according to a computer vision algorithm, the objects captured in the image information;
execute a coordinate transformation program according to a connection relationship or a rotation angle of the image capturing device relative to a plurality of reference points;
calculate, according to the coordinate transformation program, a coordinate of each of the objects in the at least one zone; and
determine, according to the coordinates, whether the objects captured in the image information are located in one of the at least one zone.

16. The robot according to claim 15, wherein the robot further comprises:
at least one component, configured to carry the image capturing device, the input device, the memory, and the processor, and the at least one component is coupled to the mobile device,
wherein the reference points comprise the at least one component and the mobile device.
